(19) United States
(12) Patent Application Publication
(10) Pub. No.: US 2023/0115079 A1
(43) Pub. Date: Apr. 13, 2023

(54) PROTECTIVE FACE MASK

(71) Applicant: ADAM MAGDI LAMEI KHALIL, SAN ANTONIO, TX (US)

(72) Inventor: ADAM MAGDI LAMEI KHALIL, SAN ANTONIO, TX (US)

(21) Appl. No.: 17/451,207

(22) Filed: Oct. 18, 2021

Related U.S. Application Data
(63) Continuation of application No. 17/450,228, filed on Oct. 7, 2021.

(51) Int. Cl. A62B 18/08; A41D 13/11

(52) U.S. Cl. CPC A62B 18/084; A41D 13/11

(57) ABSTRACT

The present disclosure relates to an improved protective face mask for consumer and professional use. The inclusion of multiple layers, including a sealing layer, provides for an enhanced seal, improved comfort, and a reduction in the fogging or obscuring of eyewear worn in conjunction with the mask.

### BACKGROUND OF THE INVENTION

The utility and need for effective masks in both professional medical settings and for everyday consumer use has only become more apparent in recent times. While masks are an effective tool in minimizing exposure to potential contaminants and reducing the risk of transmitting certain illnesses, masks still present a number of practical concerns for their wearers.

In particular, for those who also wear protective eyewear, a common issue when wearing a mask is the fogging or obscuring of that eyewear while breathing. This problem has been recognized and existed for many years. Previous attempts to address this issue have involved using thicker mask fabrics and the use of adhesives to secure the masks to the wearer's skin. None of these approaches have fully resolved the problem while they have at times created additional discomfort when wearing the mask.

In order to solve these limitations, the present invention provides a unique approach utilizing different materials and layering to enhance the overall seal created between the mask's inner surface and the wearer's skin thereby improving the functionality of the mask and reducing any fogging or obscuring of eyewear worn in conjunction with the mask.

### SUMMARY OF THE INVENTION

An object of the present invention is to provide for an improved mask that creates an enhanced seal against a wearer's skin thereby reducing any residual airflow that may result in the obscuring of corrective, or other, eyewear while simultaneously maintaining and improving the mask's ability to protect against the transmission of illness or disease (such as COVID-19).

Furthermore, use of the presently disclosed configurations of layers in accordance with the various embodiments will not significantly increase the cost of mask production and will minimize the time taken to put on and adjust the mask.

### DESCRIPTION OF THE DRAWINGS

FIG. 1 is a depiction of the various mask layers in accordance with some embodiments of the present disclosure.

FIG. 2 is a depiction of an improved mask in accordance with some embodiments of the present disclosure.

FIG. 3. is a depiction of an improved mask in a folded configuration in accordance with some embodiments of the present disclosure.

FIG. 4 is depicts a methodology of creating an improved mask in accordance with some embodiments of the present disclosure.

### DETAILED DESCRIPTION

In the following description multiple details may be established to provide a thorough understanding of the various disclosed embodiments. It should be clear that the description is not intended to limit the scope of this disclosure to these specific embodiments and those variations, changes, substitutions, or equivalent components will be apparent to those skilled in the art and should not be considered significant differences from the intended scope of the disclosure.

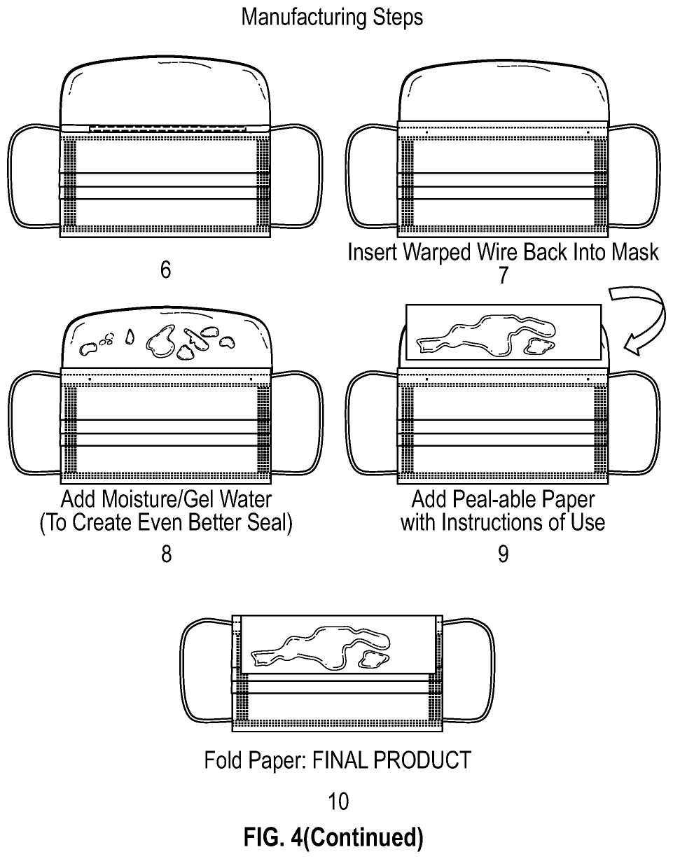

In some embodiments, a protective face mask in accordance with the present disclosure may have an outer fabric layer and an inner sealing layer. Said outer fabric layer may be composed of any material conventionally known in the art in the manufacture of protective face masks. Said inner sealing layer may be composed of thin moldable material that is configured to adhere to a wearer's skin. For example, a clinging film or other moldable plastic (such as thin, treated, or film PVC or polyethylene) may be used for said inner sealing layer. The benefits of using such a material for said sealing layer involve a stronger seal that more closely fits the contours of each wearer's face. Additionally, while described as a “layer,” said outer fabric layer and inner sealing layer may be secured to one another along an edge such that the connection forms a substantially continuous surface rather than have one overlap the other. The flexibility of a cling film in particular can provides a seal along all edges of the mask. Additionally, such cling film often reacts to moisture (such as a wearer's natural sweat) in a manner that further enhances the seal between said film and the wearer's skin. In further embodiments, a moisturizing agent may be pre-applied to the film to facilitate the creation of a seal between the mask and the wearer's skin as shown in FIG. 4. Unlike conventional approaches to enhancing the seal between mask and skin, the disclosed embodiments do not require the use of additional adhesives to hold the mask on the wearer's face, foams, or thicker mask materials.

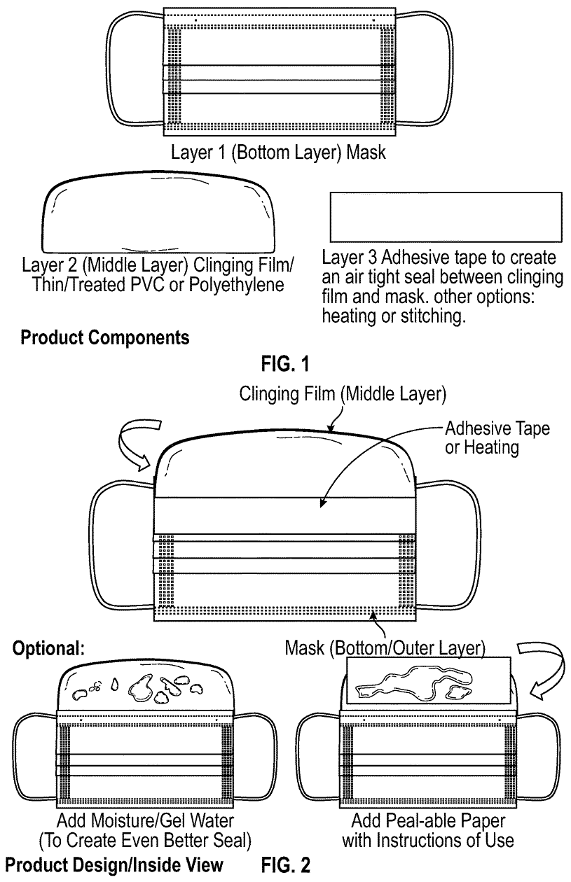

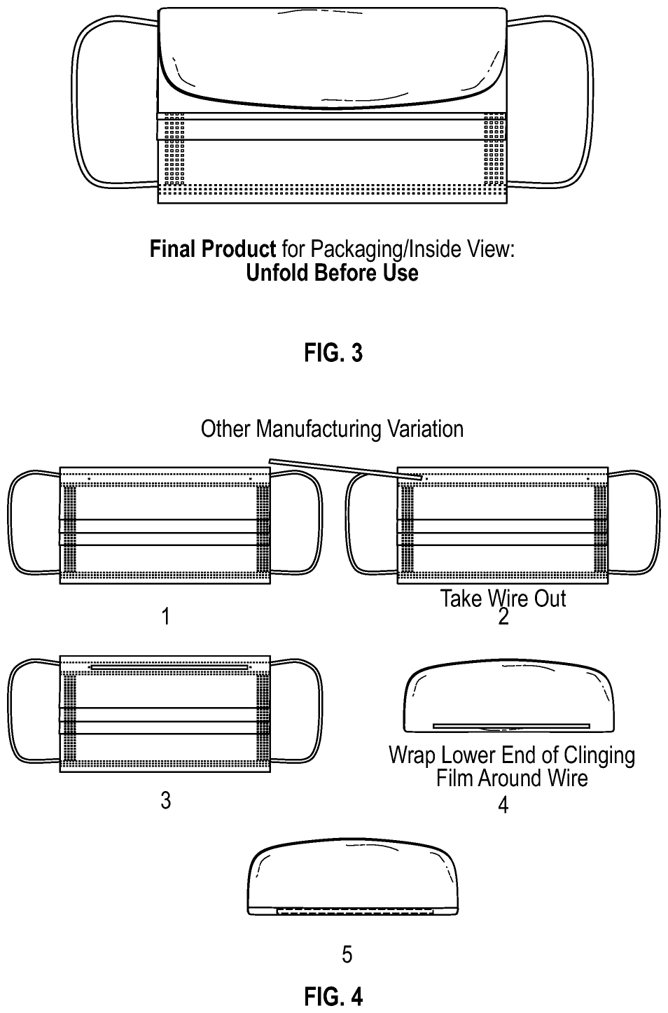

An improved protective face mask in accordance with the present disclosure may be manufactured, packaged, and provided as a discrete unit (as shown in FIGS. 1-3) or, as shown in FIG. 4, result from the modification of pre-existing face masks. Conventional face masks (surgical, N95, etc.) provide a fabric layer that is designed to cover the wearer's nose and mouth. The conventional masks also often utilize either a wire, or other bendable metallic material, to bias the fabric layer against the wearer's face. For such mask, the wire, or other bendable member, may be adhered to an inner sealing layer to effectively create mask in accordance with the present disclosure. In some embodiments, any other conventional methods for securing one material layer to another may be utilized to adhere the inner sealing layer to the outer fabric layer. The additional inner sealing layer will enhance the protective qualities of the mask by improving the seal and also the wearer's comfort by reducing any airflow that would otherwise cause the wearer's eyewear to become foggy or obscured.

In further embodiments, an interior fabric layer may also be incorporated. Said interior fabric layer may be composed of any material conventionally used for producing face masks such as polyethylene, thick pleated cotton, etc. Said interior fabric layer may be composed of the same material as said outer fabric layer. As shown in FIGS. 1-3, said interior fabric layer is disposed opposite said inner sealing layer relative said outer fabric layer. Said interior fabric layer is configured to encompass a portion of said inner sealing layer that is in contact with said outer fabric layer. The inclusion of said interior fabric layer further reduces the risk of airflow between said outer fabric layer and said inner sealing layer thereby reducing the chance of a wearer's eyewear being fogged or obscured. Said interior fabric layer may be secured to said outer fabric layer by any conventional method for securing one fabric to another.

1. A protective face mask comprising:
an outer fabric layer; and
an inner sealing layer secured to said outer fabric layer, wherein said inner sealing layer is a cling film configured for direct contact with a wearer's skin and to create a sealed attachment to said wearer's skin without application of an adhesive.

2. (canceled)

3. (canceled)

4. The protective face mask of claim 1 further comprising an interior fabric layer wherein said interior fabric layer is disposed opposite said inner sealing layer relative said outer fabric layer.

5. A method for creating a protective face mask comprising: adhering an outer fabric layer to an inner sealing layer wherein said inner sealing layer is a cling film configured for direct contract with a wearer's skin and to create a sealing attachment with said wearer's skin without application of an adhesive, and wherein said inner sealing layer is composed of a thin, moldable material.

6. (canceled)

7. The method of claim 5 further comprising adhering an interior fabric layer to said outer fabric layer such that said inner sealing layer is disposed between said interior fabric layer and said outer fabric layer.
